(19) United States
(12) Patent Application Publication
(10) Pub. No.: US 2026/0301042 A1
(43) Pub. Date: Oct. 1, 2026

(54) SYSTEM AND METHOD FOR AI-DRIVEN PRODUCT MATCHING AND CONDITION STANDARDIZATION IN SECONDHAND MARKETPLACES

(71) Applicant: SECONDSENSE CO., San Francisco, CA (US)

(72) Inventor: Christopher Lucas, Boston, MA (US)

(73) Assignee: SECONDSENSE CO., San Francisco, CA (US)

(21) Appl. No.: 19/631,423

(22) Filed: Mar. 27, 2026

Related U.S. Application Data
(60) Provisional application No. 63/779,739, filed on Mar. 28, 2025.

(51) Int. Cl. G06Q 30/0601

(52) U.S. Cl. CPC G06Q 30/06291

(57) ABSTRACT

A system and method are provided for standardized product matching and condition prediction.

### CROSS-REFERENCE TO RELATED APPLICATIONS

This application claims priority to U.S. Provisional Application No. 63/779,739, filed Mar. 28, 2025, which is herein incorporated by reference in its entirety.

### BACKGROUND OF THE DISCLOSURE

Conventional systems for price comparison, especially within secondhand marketplaces, generally are limited to relying on users performing many manual tasks. For example, these price comparison tools, such as Google Shopping® and eBay® searches, require users to manually search and compare listings. Users would have to compare prices and determine how comparable quality is on their own. Moreover, manual condition assessment is slow and inconsistent, which can lead to mispriced listings. In addition, other price comparison tools that utilize more automated techniques also fail because conditions and pricing for items are not standardized, which makes comparisons extremely difficult and mostly inaccurate. While, in some instances, basic stock keeping unit (SKU) matching can be performed, this is limited to situations where only new products are available. These techniques consistently fail when SKUs are either inconsistent or missing.

### BRIEF DESCRIPTION OF THE FIGURES

FIG. 1 is a block diagram of an example system for standardized product matching and condition prediction according to example embodiments of the present disclosure.

FIG. 2 is a flowchart of an example process for condition prediction according to example embodiments of the present disclosure.

FIG. 3 is a flowchart of an example process for standardized product matching according to example embodiments of the present disclosure.

FIG. 4 is a flowchart of an example process for historical price visualization according to some embodiments of the present disclosure.

FIG. 5 is a flowchart of an example process for a correction pipeline according to some embodiments of the present disclosure.

FIG. 6 is a diagram of an example computing device or server device.

FIG. 7 is another example of a computing device.

The drawings are not necessarily to scale, or inclusive of all elements of a system, emphasis instead generally being placed upon illustrating the concepts, structures, and techniques sought to be protected herein.

### SUMMARY OF THE INVENTION

According to one aspect of the present disclosure, a computer-implemented method, performed by at least one processor, can include retrieving a first product listing for a first item; retrieving a second product listing for a second item; determining that the first and second items match by analyzing first and second product schemas; generating a first condition prediction for the first item and a second condition prediction for the second item; determining that the first and second condition predictions match; identifying a price difference between the first and second product listings; and detecting an arbitrage based on the price difference.

In some embodiments, retrieving the first product listing comprises retrieving the first product listing from a first online marketplace. In some embodiments, retrieving the second product listing comprises retrieving the second product listing from a second online marketplace. In some embodiments, the first and second online marketplaces are the same. In some embodiments, retrieving a product listing comprises extracting a text description, listing metadata, and one or more images.

In some embodiments, generating a product schema can include analyzing, via a large language model (LLM), the text description and the listing metadata; analyzing, via at least one computer vision technique, the one or more images; and generating the product schema based on the analyzing steps. In some embodiments, determining that the first and second items match by analyzing the first and second product schemas comprises applying a semantic similarity algorithm to match the first and second items based on textual and image based attributes of the associated product schemas. In some embodiments, the LLM is fine-tuned based on data specific to a vendor or a brand associated with the first and second items.

In some embodiments, generating a condition prediction can include extracting one or more condition-related phrases from the associated product listing; extracting one or more visual indicators from one or more images associated with the product listing; and analyzing, via a multi-modal deep learning architecture, the one or more condition-related phrases and the one or more visual indicators to generate the condition prediction. in some embodiments, the multi-modal deep learning architecture can include at least one convolutional neural network (CNN) for extracting one or more condition features from the one or more images; at least one transformer or bilinear model for generating embeddings from the one or more condition-related phrases; or one or more iterative co-attention mechanisms for jointly processing the one or more condition features and the embeddings.

### DESCRIPTION

The following detailed description is merely exemplary in nature and is not intended to limit the claimed invention or the applications of its use.

There are several existing products and processes that attempt, unsuccessfully, to address aspects of secondhand marketplace aggregation, product standardization, and condition assessment. However, none of these existing systems are able to adequately address these tasks. Some platforms aggregate listings from multiple vendors but do not normalize product data at a granular level. For secondhand items where descriptions, image formats, and condition labels vary significantly, this can be extremely problematic and undesirable. Moreover, some luxury resale platforms, use manual grading systems for condition assessment, but these rely on human reviewers and are not standardized across different vendors. Certain AI-driven authentication solutions focus on detecting counterfeit items rather than grading condition across marketplaces. Additionally, price prediction models for secondhand goods, such as those used in research for jewelry resale value estimation, predict resale prices rather than performing condition-aware arbitrage detection across vendors. While AI-powered image recognition models exist for assessing damage in cars, furniture, and electronics, they are typically domain-specific and do not integrate multi-modal inputs (text + images) to harmonize condition ratings across secondhand marketplaces.

Embodiments of the disclosure are therefore directed to systems and methods for standardized product matching and condition rating, especially in secondhand marketplaces. The disclosed techniques can utilize AI models fine-tuned on a per-vendor basis to standardize product schemas, integrate multi-modal machine learning for cross-platform condition classification, enable condition-aware price arbitrage detection, price benchmarking, historical and predictive pricing analytics, inventory and pricing optimizing tools for secondhand supplies, and broader resale market intelligence applications for brands and/or other institutional users. In some embodiments, the disclosed systems and methods can ingest product data from multiple secondhand vendors and use vendor-specific or brand-specific (or combinations thereof) fine-tuned large language models (LLMs) to normalize and structure product descriptions, attributes, terminology, and condition descriptions into a standardized schema. This enables accurate detection of instances where the same product is listed on different platforms with varying descriptions and prices, ultimately highlighting arbitrage opportunities. In addition, the disclosed systems and methods can help ensure accurate condition comparisons are being made across marketplaces. The disclosed multi-modal machine learning model can take both product images (e.g., on average 5 per listing) and text descriptions (e.g., "scuffed corners, minor residue") as inputs. The model can then predict a standardized condition grading scale that harmonizes condition descriptions across vendors who may use different terminology, different scales, or no condition scale at all. The disclosed system can therefore enhance transparency, improve price discovery, and facilitate informed buying decisions for users within the secondhand economy.

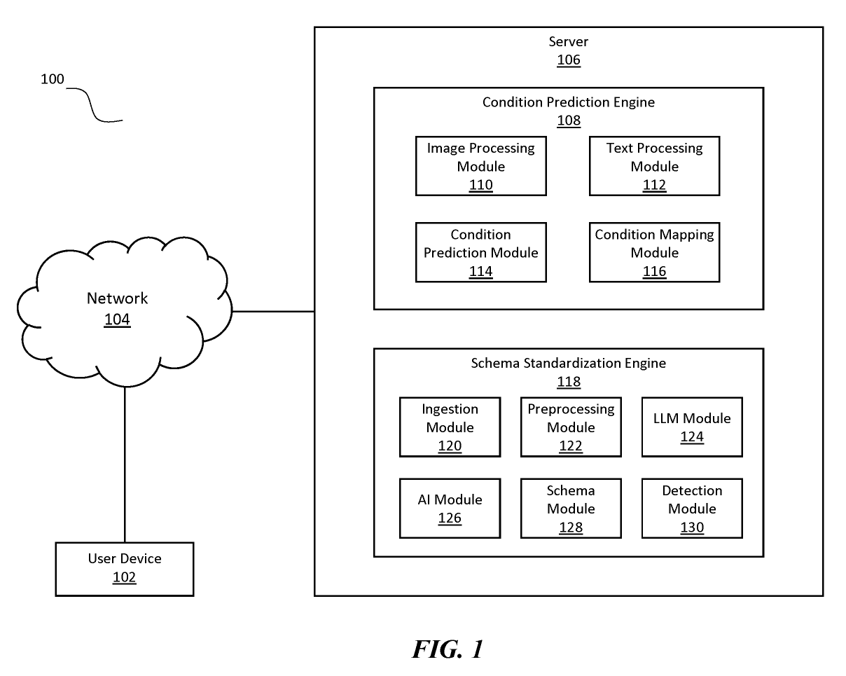

FIG. 1 is a block diagram of an example system 100 for standardized product matching and condition prediction according to example embodiments of the present disclosure. The system 100 can include one or more user devices 102 (generally referred to herein as a “user device 102” or collectively referred to herein as “user devices 102”) that can access a server 106 via a network 104 to engage within various online shopping ecosystems, such as the secondhand marketplace economy. Example secondhand marketplaces can include, but are not limited to, Facebook Marketplace®, eBay®, Poshmark®, Craigslist®, RealReal™, Fashionphile®, etc. In particular, the user device 102 can access the server 106 to utilize various tools and techniques described herein, such as the ability to utilize standardized product matching tools and condition prediction techniques.

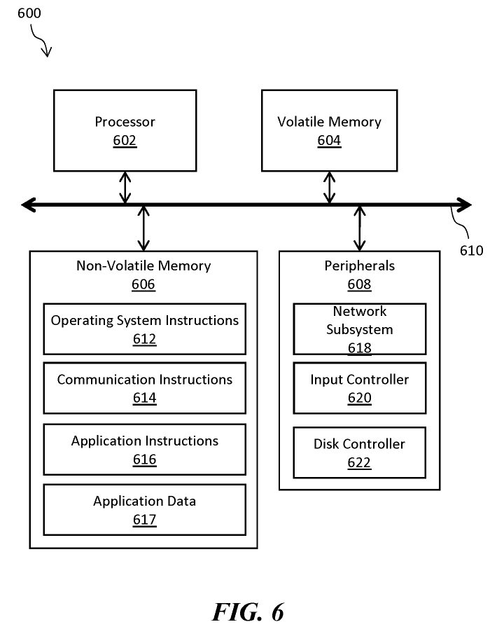

A user device 102 can include one or more computing devices capable of receiving user input, transmitting and/or receiving data via the network 104, and or communicating with the server 106. In some embodiments, a user device 102 can be a conventional computer system, such as a desktop or laptop computer. Alternatively, a user device 102 can be a device having computer functionality, such as a personal digital assistant (PDA), a mobile telephone, a smartphone, or other suitable device. In some embodiments, a user device 102 can be the same as or similar to the computing device 600 described below with respect to FIG. 6.

The network 104 can include one or more wide areas networks (WANs), metropolitan area networks (MANs), local area networks (LANs), personal area networks (PANs), or any combination of these networks. The network 104 can include a combination of one or more types of networks, such as Internet, intranet, Ethernet, twisted-pair, coaxial cable, fiber optic, cellular, satellite, IEEE 801.11, terrestrial, and/or other types of wired or wireless networks. The network 104 can also use standard communication technologies and/or protocols.

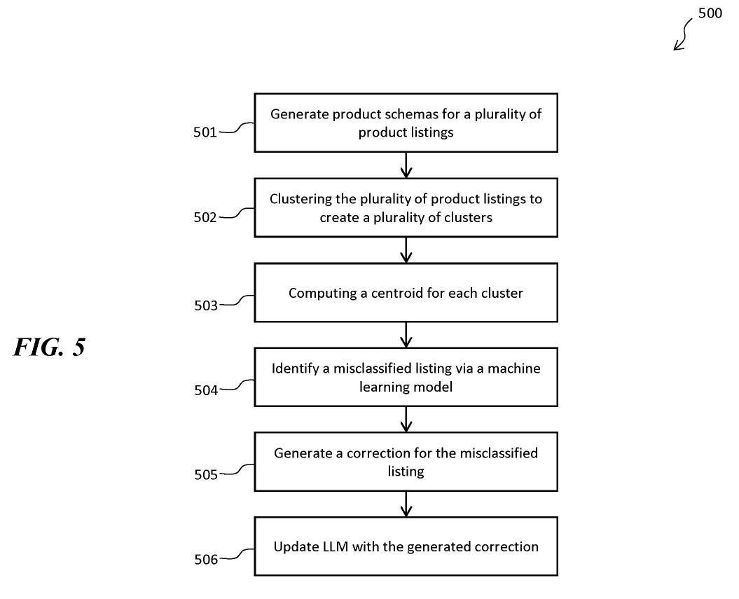

The server 106 may include any combination of one or more of web servers, mainframe computers, general-purpose computers, personal computers, or other types of computing devices. The server 106 may represent distributed servers that are remotely located and communicate over a communications network, or over a dedicated network such as a local area network (LAN). The server 106 may also include one or more back-end servers for carrying out one or more aspects of the present disclosure. In some embodiments, the server 106 may be the same as or similar to server 500 described below with respect to FIG. 5.

As shown in FIG. 1, the server 106 can include a content prediction engine 108 and a schema standardization engine 118. In some embodiments, the content prediction engine 108 can include an image processing module 110, a text processing module 112, a condition prediction module 114, and a condition mapping module 116. In some embodiments, the schema standardization engine 118 can include an ingestion module 120, a preprocessing module 122, an LLM module 124, an AI module 126, a schema module 128, and a detection module 130.

In some embodiments, the condition prediction engine 108 can be configured to predict and standardize product condition ratings across various different secondhand marketplaces. In some embodiments, the condition prediction engine 108 can analyze product images and text descriptions using deep learning to assign a standardized condition rating—enabling fair cross-platform price comparisons.

In some embodiments, the image processing module 110 can be configured to use various computer vision techniques to analyze images from a product listing. For example, the computer vision techniques can be configured to identify and analyze wear, scratches, discoloration, structural damage, and other visual indicators of condition from such images retrieved from a product listing. In some embodiments, the computer vision techniques can include one or more of a convolutional neural network (CNN), a residual neural network (ResNet), certain transformer-based models (e.g., ViT, Swin Transformer, etc.), and/or other neural network architectures. In some embodiments, the image processing module 110 can support multiple image views per product and use aggregation strategies such as average pooling, max pooling, and/or learned attention across views. In some embodiments, the image processing module 110 can be configured to normalize the images to account for inconsistent lighting, angles, and resolutions across the images.

In some embodiments, the text processing module 112 can be configured to extract various condition-related phrases from textual descriptions of a product listing. For example, condition-related phrases may be added to the description of an item listed on a secondhand marketplace, such as “minor scuffs on edges,” “like new,” and the like. In some embodiments, the text processing module 112 can utilize transformer-based language models (e.g., BERT, RoBERTa, DistilBERT), bilinear models, recurrent neural networks (e.g., LSTMs, GRUs), convolutional text encoders, or other natural language processing architectures. In some embodiments, the text processing module 112 can support fallback mechanisms in the case of missing or incomplete text.

In some embodiments, the condition prediction module 114 can be configured to generate a condition prediction (or “condition rating”) of an item from a retrieved product listing. In particular, the condition prediction module 114 can be configured to analyze the visual indicators identified by the image processing module 110 and the condition-related phrases identified by the text processing module 112 to generate the condition prediction. In some embodiments, the condition prediction module 114 can combine these visual and textual features using a multi-modal deep learning architecture. In some embodiments, the multi-modal deep learning architecture can utilize one or more of a CNN for image-based feature extraction and identification, a transformer or bilinear model for text-based embeddings (e.g., DINOv2, CLIP, ensembling of methods, etc.), and fusion techniques (e.g., iterative co-attention mechanisms) to jointly process image and textual data. In some embodiments, the fusion techniques can include concatenation, weighted averaging, element-wise operations, gated mechanisms, bilinear pooling (e.g., MCB, MLB), or attention-based methods. The fusion may occur once or in multiple stages. In some embodiments, the iterative co-attention mechanism can be configured to perform joint reasoning across visual and textual modalities by allowing one modality to attend to the other. The co-attention can be implemented using transformer-style cross-attention layers, stacked attention blocks, or other iterative or recursive attention-based models. In addition, the condition prediction module 114 can include one or more fully connected layers, optionally with dropout, activation functions, calibration (e.g., temperature scaling), and softmax or other suitable output mechanisms that enable production of a normalized score or standardized class label representing the predicted condition of the product or item. In some embodiments, the condition prediction output can be a uniform scale with six levels, although this is merely exemplary in nature.

The system architecture may support the use of any subset of the above components, and such components may be used independently, sequentially, in parallel, or in combination. The architecture may further support substitution of components with equivalents or functionally similar mechanisms, as well as extensibility to additional modalities (e.g., metadata, user feedback) or additional pre/post-processing modules.

In some embodiments, the condition mapping module 116 can be configured to map vendor-specific or brand-specific condition labels to a universal condition scale, such as the condition prediction scale utilized by the condition prediction module 114. This can ensure that cross-platform condition predictions are consistent with each other in a universal way. Moreover, this can enable fair comparisons between vendors that use different condition terminologies or omit condition descriptions entirely.

In some embodiments, the schema standardization engine 118 can be configured to, in an automated manner, normalize product listings from across multiple secondhand marketplaces. In some embodiments, the schema standardization engine 118 can be configured to apply various AI models fine-tuned on a per-vendor basis to extract, structure, and standardize product attributes, image metadata, and condition indicators. This can ultimately enable accurate cross-platform product matching and condition-aware arbitrage detection. Moreover, the schema standardization engine 118 can process unstructured product descriptions and vendor-specific or brand-specific image formatting to create a standardized product schema that can allow for precise cross-platform price analysis.

In some embodiments, the ingestion module 120 can be configured to retrieve and collect product listings from various secondhand vendors and marketplaces. In some embodiments, the ingestion module 120 can retrieve textual descriptions, images, and listing metadata from a product listing. Listing metadata can include various indicators of quality, brand, model no., etc. that a seller will typically select when listing an item for sale on a secondhand marketplace.

In some embodiments, the preprocessing module 122 can be configured to extract text descriptions, structured metadata (aka “listing metadata”), images, and condition indicators for each product within the ingested product listings.

In some embodiments, the LLM module 124 can include an LLM, such as GPT-3, -3.5, -4, PaLM-E, Ernie Bot, LLaMa, and others. In some embodiments, the LLM can include various transformed-based models trained on vast corpuses of data that utilize an underlying neural network. In some embodiments, the LLM module 124 can be manually trained/fine-tuned on various datasets associated with specific vendors. Such fine-tuning can enable the LLM module 124 to extract and normalize product attributes, such as brand, model, material, dimensions, color, SKU, condition labels, and unique listing terminology. The LLM module 124 can therefore receive an input prompt from the preprocessing module 122 for a product listing and output various normalized attributes and features associated with the product listing.

In some embodiments, the AI module 126 can be configured to utilize various computer vision techniques to analyze image metadata from the product listing and photo styles to enhance matching accuracies across different platforms. In some embodiments, the computer vision techniques can include one or more of a CNN or a ResNet.

In some embodiments, the schema module 128 can be configured to convert the extracted attributes and features into a standardized, universal schema for the item associated with the product listing. This can enable the disclosed system to identify the same product across vendors and marketplaces even when they are described differently. In some embodiments, the schema module 128 can be configured to match items from different product listings based on the textual and image-based attributes in their respective product schemas. For example, the schema module 128 can apply various semantic similarity algorithms to product schemas for separate product listings to determine if the respective items match.

In some embodiments, the detection module 130 can be configured to compare product listings that have been determined to be matching by the schema module 128. In particular, the detection module 130 can be configured to compare the product listings and assess condition equivalency, such as by comparing the condition prediction of the respective items as determined by the condition prediction module 114. In addition, the detection module 130 can be configured to highlight instances where matching products in equivalent condition (or comparable condition) are priced differently across different marketplaces and vendors.

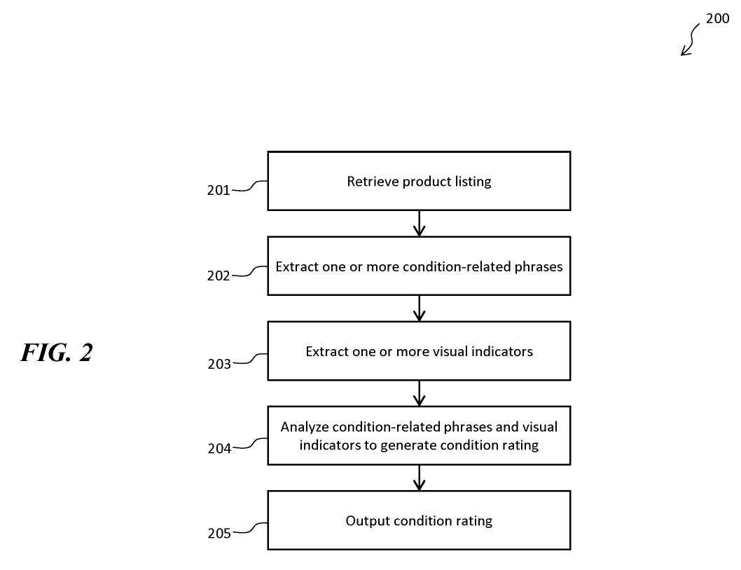

FIG. 2 is a flowchart of an example process 200 for condition prediction according to example embodiments of the present disclosure. In some embodiments, the process 200 can be performed by the server 106 and its various modules. In particular, the process 200 can be performed by the condition prediction engine 108. At block 201, the process 200 can include retrieving a product listing. In some embodiments, the product listing can be retrieved by the ingestion module 120 or another separate but similarly operable module contained within the condition prediction engine 108. In some embodiments, the product listing can include one or more of textual descriptions, one or more images, and listing metadata.

At block 202, the process 200 can include extracting, via the text processing module 112, one or more condition-related phrases from the retrieved product listing. As discussed above in relation to FIG. 1, condition-related phrases can be found in a description and can be phrases such as “minor scuffs on edges,” “like new,” and the like. In some embodiments, the text processing module 112 can utilize various natural language processing models, fine-tuned transformers, and/or LLM models to extract the condition-related phrases.

At block 203, the process 200 can include extracting, via the image processing module 110, one or more visual indicators of condition from the one or more images of the product listing. As discussed in relation to FIG. 1, the extraction of the visual indicators from the one or more images can be performed using various computer vision techniques to analyze images from a product listing. For example, the computer vision techniques can identify and analyze wear, scratches, discoloration, structural damage, and other visual indicators of condition from such images retrieved from a product listing. In some embodiments, the computer vision techniques can include one or more of a convolutional neural network (CNN) or a residual neural network (ResNet). In some embodiments, extracting the one or more visual indicators form the one or more images can also include normalizing the images, which can account for inconsistent lighting, angles, and resolutions.

At block 204, the process 200 can include analyzing, by the condition prediction module 114, the extracted condition-related phrases and visual indicators to generate a condition prediction. As discussed above in relation to FIG. 1, the generating of a condition prediction can be performed by combining visual and textual features via a multi-modal deep learning architecture. In some embodiments, the multi-modal deep learning architecture can utilize one or more of a CNN for image-based feature extraction and identification, a transformer or bilinear model for text-based embeddings, and fusion techniques (e.g., iterative co-attention mechanisms) to jointly process image and textual data. In some embodiments, the condition prediction output can be a uniform scale with five levels, although this is merely exemplary in nature.

At block 205, the process 200 can include outputting the condition prediction, such as a visual display on a user interface of a user device 102 or as a value to be utilized by other components within the system 100, such as the detection module 130 for arbitrage detection.

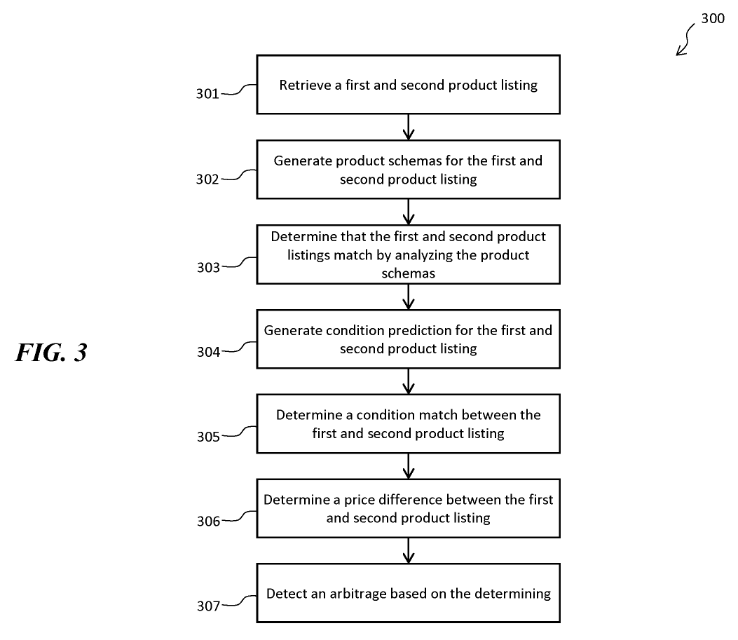

FIG. 3 is a flowchart of an example process 300 for standardized product matching according to example embodiments of the present disclosure. In some embodiments, the process 300 can be performed by the server 106 and its various modules. In particular, the process 300 can be performed by the schema standardization engine 118 and the condition prediction engine 108. At block 301, the process 300 can include retrieving, via the ingestion module 120, a first and second product listing. The first product listing can be for a first item and the second product listing can be for a second item. In some embodiments, the listings can be retrieved from different secondhand marketplaces, although this is not limiting, as the process 300 can, in some embodiments, apply to separate listings on the same platform. In some embodiments, retrieving the product listings can include retrieving textual descriptions, images, and listing metadata from the product listings. In some embodiments, retrieving the product listings can also include extracting, via the preprocessing module 122, text descriptions, structured metadata, images, and condition indicators for each product within the retrieved product listings. The preprocessed information can then be fed as an input prompt to the LLM module 124.

At block 302, the process 300 can include generating a product schema for each of the first and second product listing. In some embodiments, generating the product schema for each of the product listings can include analyzing the preprocessed information (e.g., the extracted textual description and structured metadata) via the LLM module 124 and outputting normalized attributes and features associated with the respective product listings. In addition, the AI module 126 can, via various computer vision techniques such as a CNN or a ResNet, analyze the image data of the item within the product listing to enhance subsequent matching accuracy. Then, the schema module 128 can convert the extracted attributes and features into a standardized, universal schema for the items of the first and second product listings. Therefore, the schema module 128 can generate such a standardized schema for each of the two items: the first product schema and the second product schema.

At block 303, the process 300 can include determining, via the schema module 128, that the first and second product listings match by analyzing the first and second product schemas. In some embodiments, the matching can be determined by analyzing the textual and image-based attributes in the respective schemas. In some embodiments, determining that the first and second product listings match can include applying a semantic similarity algorithm to the first and second product schemas.

At block 304, in response to determining that the first and second items match in block 303, the process 300 can include generating a condition prediction for each of the first and second product listings. In some embodiments, generating the condition prediction can be performed by the condition prediction module 114 in the same manner as described in the process 200 of FIG. 2, although this is not intended to be limiting in nature.

At block 305, the process 300 can include determining a condition match between the first and second product listings. In some embodiments, determining the condition match can include determining that the condition predictions of the two product listings are in the same “level” of the condition scale. As discussed above, the condition scale can, in some embodiments, utilize a six-point scale that reflects the condition of the item, although six is not necessarily limiting.

At block 306, the process 300 can include, in response to determining the condition match between the first and second product listings, determining a price difference between the first and second product listings. This can enable the process 300 to identify a scenario in which the same product in the same condition is listed in two separate product listings at a different price point. At block 307, in response to determining that the first and second product listings include the same item listed in the same condition but at a different price, detecting an arbitrage event. This detection can be highlighted to a user, such as the user device 102.

In alternate embodiments, blocks 306 and 307 can be replaced with alternate steps, such as price benchmarking, historical and predictive pricing analytics, inventory and pricing optimization tools, and broader resale market intelligence applications, as well as a variety of others.

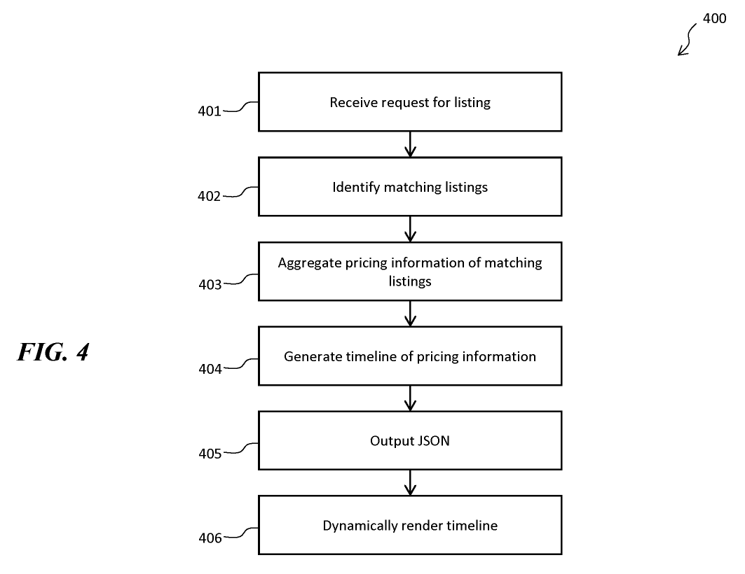

FIG. 4 is a flowchart of an example process 400 for historical price visualization according to some embodiments of the present disclosure. In some embodiments, the process 400 can enable condition-aware, product-specific techniques for market valuation for items in secondhand marketplaces. The process 400 can dynamically construct a historical pricing benchmark that is specifically tailored to the attributes and condition of a specific item in a listing. In some embodiments, the process 400 can leverage the condition standardization infrastructure of the system 100 of FIG. 1 to provide historical price tracking for secondhand listings.

At block 401, the process 400 can include receiving a request for a listing. For example, the server 106 can receive a request for a listing from the user device 102. At block 402, the process 400 can include identifying matching listings (i.e., other product listings that list matching products). In some embodiments, matching listings can be identified across different platforms. To identify matching listings, a product schema can be generated for the requested listing, such as by the schema standardization engine 118 as discussed in relation to FIG. 3. In some embodiments, the identification of matching listings can be performed in a cascading manner. For example, the identifying can first include identifying listings that have a matching product in matching condition. In other words, it includes identifying listings whose product schema exactly matches the product schema of the requested listing (e.g., same color, size, material, hardware, product model, etc.) and whose condition matches the condition of the requested product listing. Example methods for matching product schemas are discussed in relation to FIG. 3.

In some embodiments, the cascading identification can include a second step, where listings of the same product with identical size and material but different color or hardware are considered matching. In other words, the second identification step includes identifying other product listings that match the requested product listing with broader criteria for matching (i.e., relaxed criteria for color and hardware), but the listings still have a matching condition rating.

In some embodiments, the cascading identification can include a third step, where listings of the same product with different size, material, hardware, and color are considered matching. In other words, the third identification step includes identifying other product listings that match the requested product listing with even broader criteria for matching (i.e., relaxed criteria for size, material, color, hardware), but the listings still have a matching condition rating.

In some embodiments, the cascading identification can include a fourth step, where listings of the products with a matching brand and visually similar attributes (e.g., hardware, color, etc.) are considered matching. In other words, the fourth identification step includes identifying other product listings that match the requested product listing with yet broader criteria for matching (i.e., relaxed constraints for size, material, product model), but the listings again still have a matching condition rating.

In some embodiments, holding the condition of the items in the product listings constant via the disclosed condition prediction techniques (see FIG. 2) can ensure that comparisons are being made between equivalently graded items; this avoids comparing a pristine item with an item in poor condition. Moreover, such a cascading strategy of identifying matching listings can ensure a robust, high-quality match set is developed, even in sparsely populated inventory categories.

At block 403, the process 400 can include aggregating pricing information of the matching listings identified at block 402. This can include scraping and compiling the initial pricing activity, scrape date, subsequent price changes (e.g., increases, decreases, price at sale), and current price). At block 404, the process 400 can include generating a timeline of the aggregated pricing information. In some embodiments, generating the timeline can include interpolating missing values within the timeline, such as using nearest available comparison date averages. This can help account for variability in listing frequency and inventory availability. At block 405, a JSON can be output, such as to a user device 102. In some embodiments, the JSON can include the listing price history, the market average, a match type, and listing count. At block 406, the user device 102 can dynamically render the timeline, which can be a merged view of the originally requested listing’s individual price history and the condition-normalized market average for similar listings, as determined in process 400.

In some embodiments, in addition to generating a condition-normalized historical pricing benchmark, the system can extend its functionality to include forward-looking, predictive valuation. Utilizing the same AI-based infrastructure (i.e., system 100 of FIG. 1)—namely, product and variant standardization, condition classification, and structured attribute matching—the algorithm can construct time series data not only for individual listings but also for aggregated cohorts of comparable items. These cohorts can be defined by shared product attributes and equivalent standardized condition grades. By aggregating and smoothing historical price trajectories across these cohorts, the system can identify temporal patterns such as depreciation curves, seasonal price fluctuations, and inventory-driven pricing dynamics. These temporal signals, in conjunction with current market state indicators (e.g., active listings, time on market, price velocity), can then be used to forecast future pricing trends for a given listing or product category. As such, the system can serve a dual purpose: it can function as both a retrospective price normalization engine and a predictive pricing intelligence module, providing consumers with forward-looking guidance rooted in historical market behavior and condition-aware comparisons.

FIG. 5 is a flowchart of a process 500 for a correction pipeline according to some embodiments of the present disclosure. In some embodiments, the process 500 can be performed by the server 106 and its various modules. The process 500 can implement a backend clustering and correction pipeline that groups listing embeddings into product-level clusters, computes centroids, and automatically detects misclassified or duplicate listings. In some embodiments, the correction pipeline can be performed in an unsupervised manner and can be executed on top of the various classification techniques discussed herein.

At 501, the process 500 can include generating product schemas for a plurality of product listings. In some embodiments, the product schemas can be generated by the schema standardization engine 118 in a manner similar to that described in relation to FIG. 3. The product schemas can include normalized attributes and features extracted from the product listings via the LLM module 124 and the AI module 126.

At 502, the process 500 can include clustering the plurality of product listings to create a plurality of clusters. In some embodiments, the clustering can be performed based on listing embeddings derived from the product schemas. The clustering can group product listings into product-level clusters, where each cluster represents listings that correspond to the same or similar products.

At 503, the process 500 can include computing a centroid for each cluster. The centroid can represent a central point or representative embedding for the cluster. In some embodiments, the centroid can be computed as an average or weighted average of the embeddings within the cluster.

At 504, the process 500 can include identifying a misclassified listing via a machine learning model. In some embodiments, state of the art machine learning models can uncover instances where initial classifications by the LLM module 124 were incorrect. The machine learning model can analyze the distance between individual listing embeddings and their respective cluster centroids to identify listings that may have been incorrectly assigned to a cluster. In some embodiments, the machine learning model can also detect duplicate listings within or across clusters.

At 505, the process 500 can include generating a correction for the misclassified listing. In some embodiments, the correction pipeline can automatically correct, merge, or reassign misclassified or duplicate listings. For example, a misclassified listing can be reassigned to a different cluster that more accurately represents the product. Duplicate listings can be merged or flagged for removal.

At 506, the process 500 can include updating the LLM module 124 with the generated correction. In some embodiments, the corrections from the clustering pipeline can be stored and reused as labeled examples to further fine-tune the matching and embedding models. This can create a continuous feedback loop that improves accuracy over time. The corrections can be utilized to feedback into the original models used by the LLM module 124 to improve the accuracy of subsequent classifications. As such, the process 500 can enable the system 100 to continuously learn from misclassifications and improve product matching and schema generation accuracy through iterative refinement.

Although the description above describes specific examples and embodiments, variations to these examples are possible without departing from the scope of the present disclosure. Components described herein can be substituted with equivalents or functionally similar mechanisms. For example, different types of neural network architectures can be used in place of those specifically mentioned, such as substituting one type of transformer model for another or using alternative fusion techniques for combining multi-modal data. The system can be extended to incorporate additional modalities beyond text and images, such as metadata, user feedback, seller ratings, or other data sources that may provide additional signals for condition assessment or product matching. Similarly, different machine learning models can be employed for clustering, embedding generation, or classification tasks, and the specific algorithms used for semantic similarity matching can be varied based on implementation preferences or performance characteristics.

Furthermore, steps may be added to or eliminated from the described flows, and other components may be added to or removed from the described systems. For instance, additional preprocessing steps can be incorporated to handle specific data formats or vendor-specific quirks, or certain steps can be omitted when the corresponding data is unavailable or unnecessary for a particular use case. The order of certain operations can be modified where dependencies permit, and parallel processing can be employed for steps that do not depend on one another. The system architecture can be adapted to operate in distributed computing environments, cloud-based deployments, or edge computing scenarios. Additional modules can be incorporated to support new functionality, such as authentication verification, fraud detection, or integration with external pricing databases. The disclosed techniques can also be applied to domains beyond secondhand marketplaces, including new product comparison, rental markets, or other contexts where product matching and condition assessment are relevant.

FIG. 6 is a diagram of an example computing device or server device. Server 600 can implement various features and processes as described herein. Server 600 can be implemented on any electronic device that runs software applications derived from complied instructions, including without limitation personal computers, servers, smart phones, media players, electronic tablets, game consoles, email devices, etc. In some implementations, server 600 can include one or more processors 602, volatile memory 604, non-volatile memory 606, and one or more peripherals 608. These components can be interconnected by one or more computer buses 610.

Processor(s) 602 can use any known processor technology, including but not limited to graphics processors and multi-core processors. Suitable processors for the execution of a program of instructions can include, by way of example, both general and special purpose microprocessors, and the sole processor or one of multiple processors or cores, of any kind of computer. Bus 610 can be any known internal or external bus technology, including but not limited to ISA, EISA, PCI, PCI Express, USB, Serial ATA, or FireWire. Volatile memory 604 can include, for example, SDRAM. Processor 602 can receive instructions and data from a read-only memory or a random access memory or both. Essential elements of a computer can include a processor for executing instructions and one or more memories for storing instructions and data.

Non-volatile memory 606 can include by way of example semiconductor memory devices, such as EPROM, EEPROM, and flash memory devices; magnetic disks such as internal hard disks and removable disks; magneto-optical disks; and CD-ROM and DVD-ROM disks. Non-volatile memory 606 can store various computer instructions including operating system instructions 612, communication instructions 614, application instructions 616, and application data 617. Operating system instructions 612 can include instructions for implementing an operating system (e.g., Mac OS®, Windows®, or Linux). The operating system can be multi-user, multiprocessing, multitasking, multithreading, real-time, and the like. Communication instructions 614 can include network communications instructions, for example, software for implementing communication protocols, such as TCP/IP, HTTP, Ethernet, telephony, etc. Application instructions 616 can include instructions for various applications. Application data 617 can include data corresponding to the applications.

Peripherals 608 can be included within server device 600 or operatively coupled to communicate with server device 600. Peripherals 608 can include, for example, network subsystem 618, input controller 620, and disk controller 622. Network subsystem 618 can include, for example, an Ethernet of WiFi adapter. Input controller 620 can be any known input device technology, including but not limited to a keyboard (including a virtual keyboard), mouse, track ball, and touch-sensitive pad or display. Disk controller 622 can include one or more mass storage devices for storing data files; such devices include magnetic disks, such as internal hard disks and removable disks; magneto-optical disks; and optical disks.

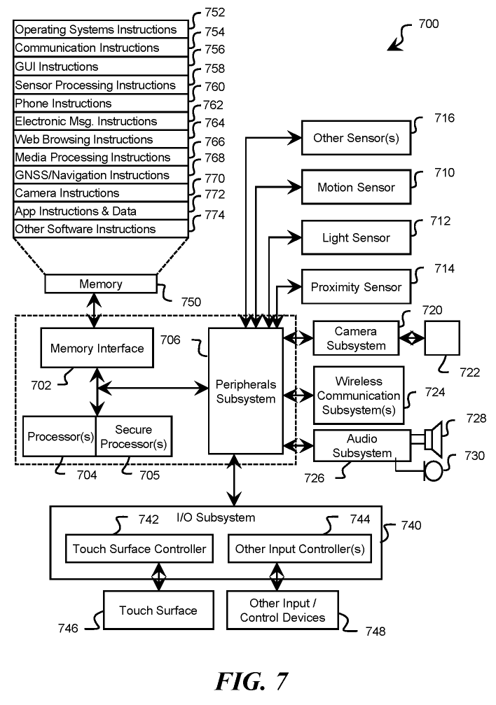

FIG. 7 is another example of a computing device. The illustrative user device 700 can include a memory interface 702, one or more data processors, image processors, central processing units 704, and or secure processing units 705, and peripherals subsystem 706. Memory interface 702, one or more central processing units 704 and or secure processing units 705, and or peripherals subsystem 706 can be separate components or can be integrated in one or more integrated circuits. The various components in user device 700 can be coupled by one or more communication buses or signal lines.

Sensors, devices, and subsystems can be coupled to peripherals subsystem 706 to facilitate multiple functionalities. For example, motion sensor 710, light sensor 712, and proximity sensor 714 can be coupled to peripherals subsystem 706 to facilitate orientation, lighting, and proximity functions. Other sensors 716 can also be connected to peripherals subsystem 706, such as a global navigation satellite system (GNSS) (e.g., GPS receiver), a temperature sensor, a biometric sensor, magnetometer, or other sensing device, to facilitate related functionalities.

Camera subsystem 720 and optical sensor 722, e.g., a charged coupled device (CCD) or a complementary metal-oxide semiconductor (CMOS) optical sensor, can be utilized to facilitate camera functions, such as recording photographs and video clips. Camera subsystem 720 and optical sensor 722 can be used to collect images of a user to be used during authentication of a user, e.g., by performing facial recognition analysis.

Communication functions can be facilitated through one or more wired and or wireless communication subsystems 724, which can include radio frequency receivers and transmitters and or optical (e.g., infrared) receivers and transmitters. For example, the Bluetooth (e.g., Bluetooth low energy (BTLE)) and or WiFi communications described herein can be handled by wireless communication subsystems 724. The specific design and implementation of communication subsystems 724 can depend on the communication network(s) over which the user device 700 is intended to operate. For example, user device 700 can include communication subsystems 724 designed to operate over a GSM network, a GPRS network, an EDGE network, a WiFi or WiMax network, and a Bluetooth™ network. For example, wireless communication subsystems 724 can include hosting protocols such that device 700 can be configured as a base station for other wireless devices and or to provide a WiFi service.

Audio subsystem 726 can be coupled to speaker 728 and microphone 730 to facilitate voice-enabled functions, such as speaker recognition, voice replication, digital recording, and telephony functions. Audio subsystem 726 can be configured to facilitate processing voice commands, voice-printing, and voice authentication, for example.

I/O subsystem 740 can include a touch-surface controller 742 and or other input controller(s) 744. Touch-surface controller 742 can be coupled to a touch-surface 746. Touch-surface 746 and touch-surface controller 742 can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with touch-surface 746.

The other input controller(s) 744 can be coupled to other input/control devices 748, such as one or more buttons, rocker switches, thumb-wheel, infrared port, USB port, and or a pointer device such as a stylus. The one or more buttons (not shown) can include an up/down button for volume control of speaker 728 and or microphone 730.

In some implementations, a pressing of the button for a first duration can disengage a lock of touch-surface 746; and a pressing of the button for a second duration that is longer than the first duration can turn power to user device 700 on or off. Pressing the button for a third duration can activate a voice control, or voice command, module that enables the user to speak commands into microphone 730 to cause the device to execute the spoken command. The user can customize a functionality of one or more of the buttons. Touch-surface 746 can, for example, also be used to implement virtual or soft buttons and or a keyboard.

In some implementations, user device 700 can present recorded audio and or video files, such as MP3, AAC, and MPEG files. In some implementations, user device 700 can include the functionality of an MP3 player, such as an iPod™. User device 700 can, therefore, include a 36-pin connector and or 8-pin connector that is compatible with the iPod. Other input/output and control devices can also be used.

Memory interface 702 can be coupled to memory 750. Memory 750 can include high-speed random access memory and or non-volatile memory, such as one or more magnetic disk storage devices, one or more optical storage devices, and or flash memory (e.g., NAND, NOR). Memory 750 can store an operating system 752, such as Darwin, RTXC, LINUX, UNIX, OS X, Windows, or an embedded operating system such as VxWorks.

Operating system 752 can include instructions for handling basic system services and for performing hardware dependent tasks. In some implementations, operating system 752 can be a kernel (e.g., UNIX kernel). In some implementations, operating system 752 can include instructions for performing voice authentication.

Memory 750 can also store communication instructions 754 to facilitate communicating with one or more additional devices, one or more computers and or one or more servers. Memory 750 can include graphical user interface instructions 756 to facilitate graphic user interface processing; sensor processing instructions 758 to facilitate sensor-related processing and functions; phone instructions 760 to facilitate phone-related processes and functions; electronic messaging instructions 762 to facilitate electronic messaging-related process and functions; web browsing instructions 764 to facilitate web browsing-related processes and functions; media processing instructions 766 to facilitate media processing-related functions and processes; GNSS/Navigation instructions 768 to facilitate GNSS and navigation-related processes and instructions; and or camera instructions 770 to facilitate camera-related processes and functions.

Memory 750 can store application (or “app”) instructions and data 772, such as instructions for the apps described above in the context of FIGS. 1-5. Memory 750 can also store other software instructions 774 for various other software applications in place on device 700.

The described features can be implemented in one or more computer programs that can be executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language (e.g., Objective-C, Java), including compiled or interpreted languages, and it can be deployed in any form, including as a stand-alone program or as a module, component, subroutine, or other unit suitable for use in a computing environment.

Suitable processors for the execution of a program of instructions can include, by way of example, both general and special purpose microprocessors, and the sole processor or one of multiple processors or cores, of any kind of computer. Generally, a processor can receive instructions and data from a read-only memory or a random access memory or both. The essential elements of a computer may include a processor for executing instructions and one or more memories for storing instructions and data. Generally, a computer may also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data may include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory may be supplemented by, or incorporated in, ASICs (application-specific integrated circuits).

To provide for interaction with a user, the features may be implemented on a computer having a display device such as an LED or LCD monitor for displaying information to the user and a keyboard and a pointing device such as a mouse or a trackball by which the user may provide input to the computer.

The features may be implemented in a computer system that includes a back-end component, such as a data server, or that includes a middleware component, such as an application server or an Internet server, or that includes a front-end component, such as a client computer having a graphical user interface or an Internet browser, or any combination thereof. The components of the system may be connected by any form or medium of digital data communication such as a communication network. Examples of communication networks include, e.g., a telephone network, a LAN, a WAN, and the computers and networks forming the Internet.

The computer system may include clients and servers. A client and server may generally be remote from each other and may typically interact through a network. The relationship of client and server may arise by virtue of computer programs running on the respective computers and having a client-server relationship to each other.

One or more features or steps of the disclosed embodiments may be implemented using an API. An API may define one or more parameters that are passed between a calling application and other software code (e.g., an operating system, library routine, function) that provides a service, that provides data, or that performs an operation or a computation.

The API may be implemented as one or more calls in program code that send or receive one or more parameters through a parameter list or other structure based on a call convention defined in an API specification document. A parameter may be a constant, a key, a data structure, an object, an object class, a variable, a data type, a pointer, an array, a list, or another call. API calls and parameters may be implemented in any programming language. The programming language may define the vocabulary and calling convention that a programmer will employ to access functions supporting the API.

In some implementations, an API call may report to an application the capabilities of a device running the application, such as input capability, output capability, processing capability, power capability, communications capability, etc.

While various embodiments have been described above, it should be understood that they have been presented by way of example and not limitation. It will be apparent to persons skilled in the relevant art(s) that various changes in form and detail may be made therein without departing from the spirit and scope. In fact, after reading the above description, it will be apparent to one skilled in the relevant art(s) how to implement alternative embodiments. For example, other steps may be provided, or steps may be eliminated, from the described flows, and other components may be added to, or removed from, the described systems. Accordingly, other implementations are within the scope of the following claims.

In addition, it should be understood that any figures which highlight the functionality and advantages are presented for example purposes only. The disclosed methodology and system are each sufficiently flexible and configurable such that they may be utilized in ways other than that shown.

Although the term “at least one” may often be used in the specification, claims and drawings, the terms “a”, “an”, “the”, “said”, etc. also signify “at least one” or “the at least one” in the specification, claims and drawings.

Finally, it is the applicant's intent that only claims that include the express language "means for" or "step for" be interpreted under 35 U.S.C. 112(f). Claims that do not expressly include the phrase "means for" or "step for" are not to be interpreted under 35 U.S.C. 112(f).

1. A computer-implemented method, performed by at least one processor, comprising:
retrieving a first product listing for a first item;
retrieving a second product listing for a second item;
determining that the first and second items match by analyzing first and second product schemas;
generating a first condition prediction for the first item and a second condition prediction for the second item;
determining that the first and second condition predictions match;
identifying a price difference between the first and second product listings; and
detecting an arbitrage based on the price difference.

2. The computer-implemented method of claim 1, wherein retrieving the first product listing comprises retrieving the first product listing from a first online marketplace.

3. The computer-implemented method of claim 2, wherein retrieving the second product listing comprises retrieving the second product listing from a second online marketplace.

4. The computer-implemented method of claim 3, wherein the first and second online marketplaces are the same.

5. The computer-implemented method of claim 1, wherein retrieving a product listing comprises extracting a text description, listing metadata, and one or more images.

6. The computer-implemented method of claim 5, wherein generating a product schema comprises:
analyzing, via a large language model (LLM), the text description and the listing metadata;
analyzing, via at least one computer vision technique, the one or more images; and
generating the product schema based on the analyzing steps.

7. The computer-implemented method of claim 6, wherein determining that the first and second items match by analyzing the first and second product schemas comprises applying a semantic similarity algorithm to match the first and second items based on textual and image based attributes of the associated product schemas.

8. The computer-implemented method of claim 6, wherein the LLM is fine-tuned based on data specific to a vendor or a brand associated with the first and second items.

9. The computer-implemented method of claim 1, wherein generating a condition prediction comprises:
extracting one or more condition-related phrases from the associated product listing;
extracting one or more visual indicators from one or more images associated with the product listing; and
analyzing, via a multi-modal deep learning architecture, the one or more condition-related phrases and the one or more visual indicators to generate the condition prediction.

10. The computer-implemented method of claim 9, wherein the multi-modal deep learning architecture comprises:
at least one convolutional neural network (CNN) for extracting one or more condition features from the one or more images;
at least one transformer or bilinear model for generating embeddings from the one or more condition-related phrases; or
one or more iterative co-attention mechanisms for jointly processing the one or more condition features and the embeddings.

11. A computing system comprising:
a processor; and
a non-transitory computer-readable storage device storing computer-executable instructions, the instructions when executed by the processor cause the processor to perform operations comprising:
receiving a connection request from a user device to interface with an expert;
retrieving a first product listing for a first item;
retrieving a second product listing for a second item;
determining that the first and second items match by analyzing first and second product schemas;
generating a first condition prediction for the first item and a second condition prediction for the second item;
determining that the first and second condition predictions match;
identifying a price difference between the first and second product listings; and
detecting an arbitrage based on the price difference.

12. The computing system of claim 11, wherein retrieving the first product listing comprises retrieving the first product listing from a first online marketplace.

13. The computing system of claim 12, wherein retrieving the second product listing comprises retrieving the second product listing from a second online marketplace.

14. The computing system of claim 13, wherein the first and second online marketplaces are the same.

15. The computing system of claim 11, wherein retrieving a product listing comprises extracting a text description, listing metadata, and one or more images.

16. The computing system of claim 15, wherein generating a product schema comprises:
analyzing, via a large language model (LLM), the text description and the listing metadata;
analyzing, via at least one computer vision technique, the one or more images; and
generating the product schema based on the analyzing steps.

17. The computing system of claim 16, wherein determining that the first and second items match by analyzing the first and second product schemas comprises applying a semantic similarity algorithm to match the first and second items based on textual and image based attributes of the associated product schemas.

18. The computing system of claim 16, wherein the LLM is fine-tuned based on data specific to a vendor or a brand associated with the first and second items.

19. The computing system of claim 11, wherein generating a condition prediction comprises:
extracting one or more condition-related phrases from the associated product listing;
extracting one or more visual indicators from one or more images associated with the product listing; and
analyzing, via a multi-modal deep learning architecture, the one or more condition-related phrases and the one or more visual indicators to generate the condition prediction.

20. The computing system of claim 19, wherein the multi-modal deep learning architecture comprises:
at least one convolutional neural network (CNN) for extracting one or more condition features from the one or more images;
at least one transformer or bilinear model for generating embeddings from the one or more condition-related phrases; or
one or more iterative co-attention mechanisms for jointly processing the one or more condition features and the embeddings.
